(19) United States
(12) Patent Application Publication
(10) Pub. No.: US 2006/0182364 A1
(43) Pub. Date: Aug. 17, 2006

(54) System and method for sharpening vector-valued digital images

(76) Inventor: George John, Austin, TX (US)

Correspondence Address: ANDERSON & JANSSON, L.L.P., 9501 N. CAPITAL OF TX HWY. #202, AUSTIN, TX, 78759, US

(21) Appl. No.: 11/059,009

(22) Filed: Feb. 16, 2005

(51) Int. Cl. G06K 9/40

(52) U.S. Cl. 382/260

(57) ABSTRACT

Sharpening multi-spectral digital images without increasing noise is accomplished by filtering vector values rather than independent scalar values. A low-pass filter is performed on image A to obtain a blurred image B1 with noise and signal suppressed. The resulting blurred image B1 is subtracted from the original image A to produce a high frequency band C1 that contains noise and signal. Vector difference mean filtering is performed on the original image A to produce a filtered image B2 with noise suppressed. The filtered image B2 is subtracted from the original image A to produce a noise band C2 that contains noise with very little signal. The noise band C2 is subtracted from the high frequency band C1 to produce a signal band D that contains the signal. The signal band D is then added to the filtered image B2 to further enhance detail in the noise filtered band.

### FIELD OF THE INVENTION

The present invention relates generally to the field of processing image data; and more particularly to a system and method for processing multi-spectral digital images to sharpen edge details without increasing noise.

### BACKGROUND OF THE INVENTION

This application incorporates by-reference U.S. utility patent application “System and Method for a vector difference mean filter for noise suppression,” Ser. No. 10/992,409, filed Nov. 18, 2004 by Mark Shulze and the current inventor, George John. In this prior patent application, reduction of noise in digitized vector-valued, multi-spectral digital images is provided by filtering based on vector values rather than independent scalar values. Vector values refer to a pixel-with two or more values. Examples of vector-valued, multi-spectral images include RGB (red, green, blue) images or amplitude, phase vectors for images such as holograms. The '409 application describes methods for capturing digital images by devices such as cameras and scanners, compressing those images, transmitting them to remote locations, and further processing them typically create disturbances in the images called “noise.” Such noise throughout the pixels of an image may detract from the image's quality and may cause difficulties in further processing that image to modify it for corrections, enhancements, and other changes.

For example, prior techniques exist for using simple averaging filters, such as high-pass filters, to sharpen the details in blurry digital images. These prior techniques often sharpen some image details effectively, but they also typically create other undesirable artifacts in the images.

FIG. 1 is a graph representing a simple, well defined edge in a digital image, plotted by pixel intensity value and location. The human eye typically finds such a sharp edge satisfactory.

If a high-pass filter is performed on a digital image to sharpen edge details, a simple edge in the image may be sharpened, as shown in FIG. 2. When such a high-pass filtered edge is added back into the original image, as is typically done in sharpening techniques, the resulting edge may be sharpened, as shown in FIG. 3. The current invention relates to improving an image by sharpening edge detail without increasing noise. Additional processing may be performed with other techniques in order to reduce ringing in the image.

However, when a digital image is noisy, sharpening techniques may increase noise undesirably. FIG. 4 shows a representative graph of a digital image with a noisy edge. Note that the range in pixel intensity values at both the top and bottom of the graph is approximately five units.

If a high-pass filter is performed on this noisy edge and the resulting value is added back into the original image, the final sharpened image typically contains increased noise, as shown in FIG. 5. The range in pixel intensity values at both the top and bottom of the graph has increased to approximately ten units.

Many methods have been developed for limiting increases in noise when sharpening digital images. For example, U.S. Pat. No. 6,373,992 for Nagao provides a method for processing a digital image for noise suppression and sharpness enhancement without causing any artificiality and oddities due to “blurry graininess.” This method comprises using a sharpening process; a smoothing process; edge detection; determination of grainy fluctuation compressing coefficient data; using the coefficient data to compress only the grainy fluctuation component in the grainy region, and to thereby create second edge/grain composite image data; and adding the second edge/grain composite image data to the smoothed image data to thereby create a processed image.

U.S. Pat. No. 6,055,340 for Nagao provides a related method that involves performing a nonlinear transformation on edge and noise data to separate a noise component and using other techniques to determine weighting data useful for correcting sharpening images to limit increases in noise.

Similarly U.S. patent application 20040066850 for Nakajima teaches an image processing method to suppress the mottled granular noise contained in color image signals and enhance the sharpness of the image, without generating noises similar to color misregistration and false color contour appearing close to the edge. The image processing method includes the steps of: converting the image signals to luminance signals and chrominance signals; applying a Dyadic Wavelet transform processing to at least the luminance signals; suppressing a signal intensity of a high-frequency luminance component at P-th level, when the intensity of the high-frequency luminance component conforms to a specific condition; applying a Dyadic Wavelet inverse-transform processing to transformed and processed signals; and synthesizing processed luminance signals and the chrominance signals with each other to generate processed image signals.

However, prior methods such as those described in U.S. Pat. Nos. 6,373,992 and 6,055,340 for Nagao still tend to cause significant undesirable artifacts in sharpened digital images because they perform their techniques separately on independent scalar values, which are individual color bands, as explained in “System and Method for a Vector Difference Mean Filter for Noise Suppression,” cited above. For example, filters that supply replacement values through averaging surrounding pixels in separate color areas tend to cause image distortions because they distort the balance among the separate areas of color near edges, typically causing undesirable artifacts.

In addition prior methods such as U.S. patent application 20040066850 for Nakajima typically operate on three color bands, red, green, and blue, and are not applicable to all vector-valued, multi-spectral images, which may have more than three component planes. Moreover, technique described in U.S. patent application 20040066850 for Nakajima is computing intensive, which makes it expensive.

Therefore there is a need for a system and method for processing multi-spectral digital images to sharpen edge details without increasing noise by filtering based on vector values rather than independent scalar values.

### BRIEF SUMMARY OF THE INVENTION

These and other needs are addressed by the present invention. The following explanation describes the present invention by way of example and not by way of limitation.

It is an aspect of the present invention to provide a method for sharpening multi-spectral digital images without increasing noise through filtering vector values rather than independent scalar values.

It is another aspect of the present invention to provide a system for sharpening multi-spectral digital images without increasing noise.

These and other aspects, features, and advantages are achieved according to the method and system of the present invention. In accordance with the present invention, sharpening multi-spectral digital images without increasing noise is accomplished by filtering vector values rather than independent scalar values. A low-pass filter is performed on an original image A to obtain a blurred image B1 with noise and signal suppressed. The resulting blurred image B1 is subtracted from image A to produce a high frequency band C1 that contains noise and signal. Vector difference mean filtering is performed on the original image A to produce a filtered image B2 with noise suppressed. The filtered image B2 is subtracted from image A to produce a noise band C2 that contains noise with very little signal. The noise band C2 is subtracted from the high frequency band C1 to produce a signal band D that contains the signal. The signal band D is then added to the filtered image B2 to further enhance edge detail in the noise filtered band.

### BRIEF DESCRIPTION OF THE DRAWINGS

The following embodiment of the present invention is described by way of example only, with reference to the accompanying drawings, in which:

FIG. 1 is a graph that illustrates a simple edge in a digital image;

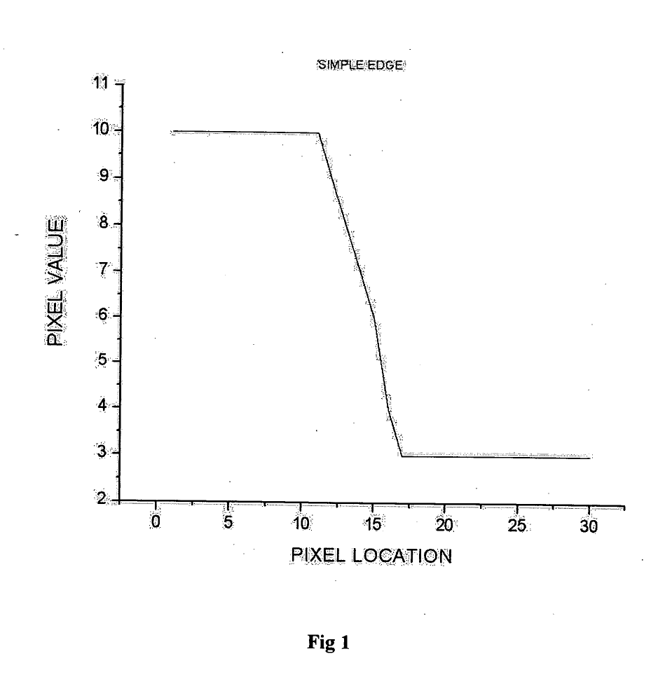

FIG. 2 is a graph that illustrates a high-pass filtered simple edge;

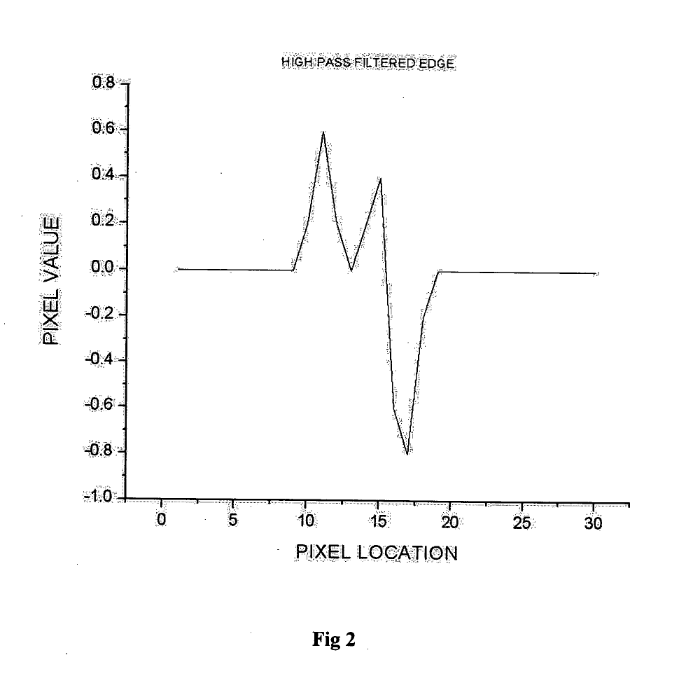

FIG. 3 is a graph that illustrates a high-pass filtered simple edge added back into the original simple edge;

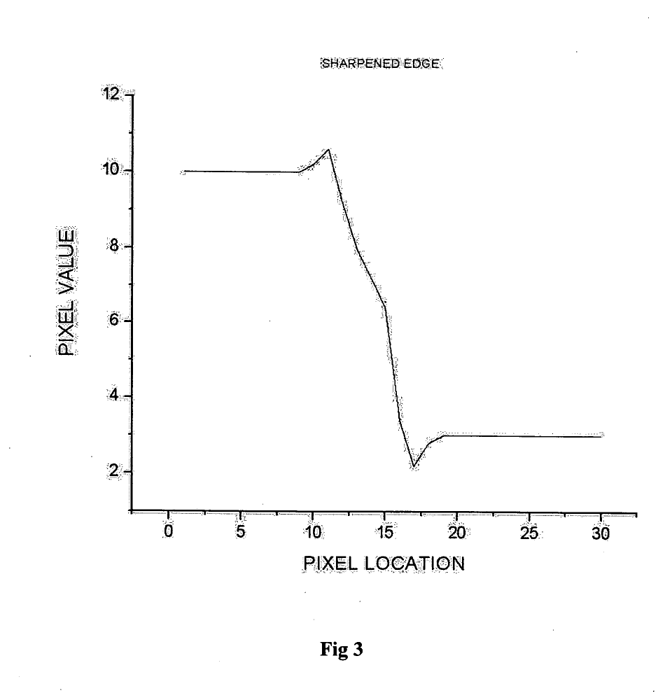

FIG. 4 is a graph that illustrates a noisy edge;

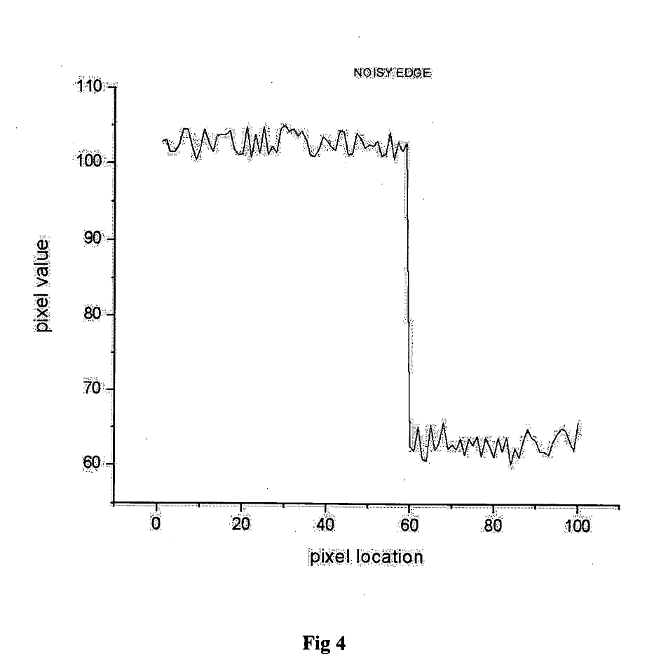

FIG. 5 is a graph that illustrates a high-pass filtered noisy edge added back into the original noisy edge;

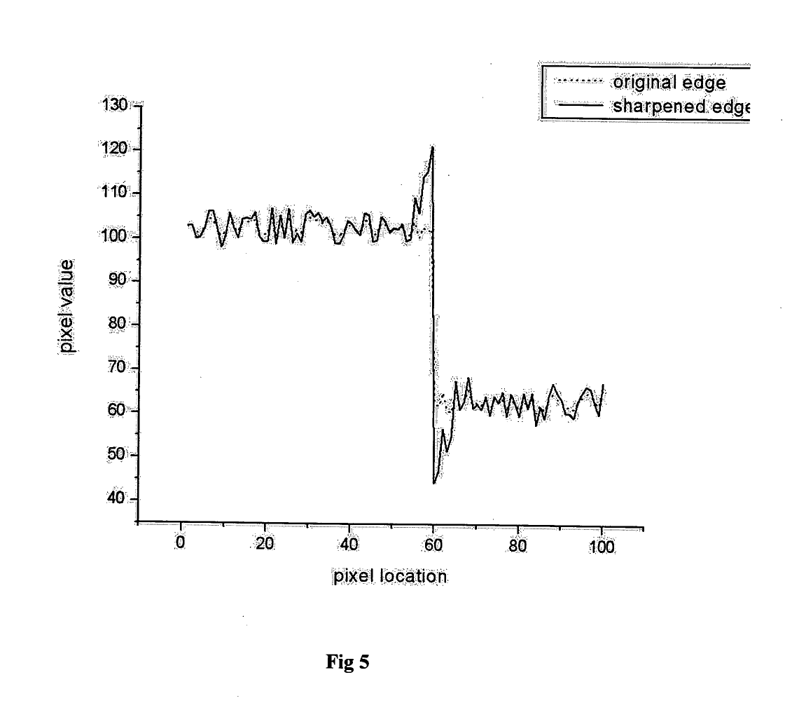

FIG. 6 is a block diagram showing an operating environment in which embodiments of the present invention may be employed;

FIG. 7 is top-level flow chart that illustrates a process for sharpening digital images by filtering based on vector values;

FIG. 8 is a flow chart showing the processes that the present invention's sharpening software accomplishes.

FIG. 9 is a graph showing a digitized multi-spectral image A with a color edge;

FIG. 10 is a graph showing a blurred image B1 created by the low-pass filtering of digitized multi-spectral image A;

FIG. 11 is a graph showing a high frequency band C1 produced by subtracting blurred image B1 from the original image A;

FIG. 12 is a graph showing a filtered image B2 produced by performing vector difference mean filtering on the original image A;

FIG. 13 is a graph showing a noise band C2 produced by subtracting filtered image B2 from the original image A;

FIG. 14 is a graph showing a signal band D produced by subtracting the noise band C2 from the high frequency band C1;

FIG. 15 is a graph showing the edge with enhanced detail produced by adding the signal band D to the filtered image B2;

FIG. 16 is a block diagram that illustrates a typical computer; and

FIG. 17 is a block diagram that shows an alternate operating environment in which embodiments of the present invention may be employed.

### DETAILED DESCRIPTION

The details of the following explanation are offered to illustrate the present invention clearly. However, it will be apparent to those skilled in the art that the concepts of the present invention are not limited to these specific details. Commonly known elements are also shown in block diagrams and flow charts for clarity, as examples and not as limitations of the present invention.

Operating Environment

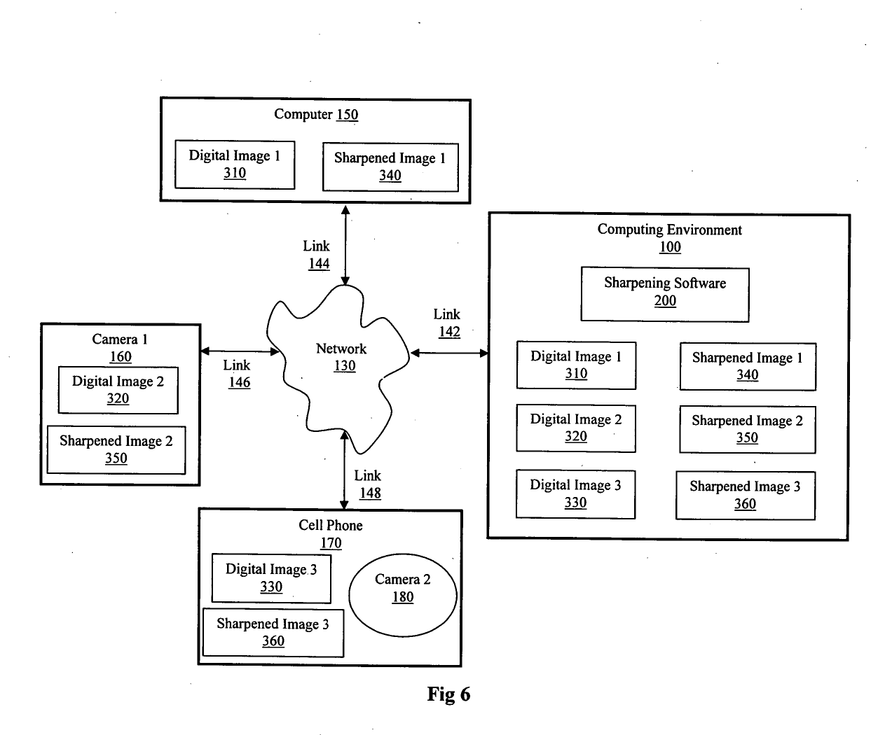

An embodiment of an operating environment of the present invention is shown in FIG. 6. One or more programmers at a computing environment 100 create sharpening software 200, employing the techniques of the present invention, explained in detail below.

Multiple remote devices, for example computer 150, camera 1 160, and cell phone (cellular telephone) 170, equipped with camera 2 180, can employ wired or wireless links 144, 146, and 148, network 130, and a wired or wireless link 142 to communicate with computing environment 100, and computing environment 100 can use the same system to communicate with these devices. Computing environment 100 may be, for example, a personal computer or a larger computerized system or combination of systems. The network 130 may be the Internet, a private LAN (Local Area Network), a wireless network, a TCP/IP (Transmission Control Protocol/Internet Protocol) network, or other communications system, and can comprise multiple elements such as gateways, routers, and switches. Links 142, 144, 146, and 148 use technology appropriate for communications with network 130.

Through the operating environment shown in FIG. 6, computer 150 can send digital image 1 310 to computing environment 100 to be processed for sharpening. Computing environment 100 receives digital image 1 310 and automatically holds it in volatile memory and processes it with sharpening software 200 to produce sharpened image 1 340, in which noise is also suppressed. Computing environment 100 then automatically transmits sharpened image 1 340 to computer 150.

Similarly, camera 1 160 can send digital image 2 320 to computing environment 100 for noise reduction, and cell phone 170 can send digital image 3 330. Computing environment 100 can then process these images and send sharpened image 2 350 to camera 1 160 and sharpened image 3 360 to cell phone 170.

Sharpening Process

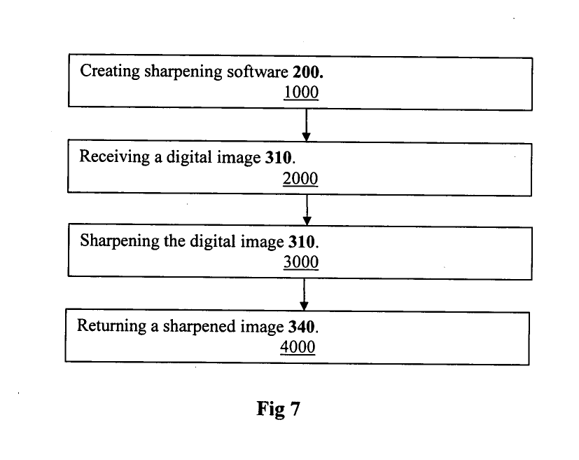

FIG. 7 is top-level flow chart that illustrates an embodiment of a process for sharpening digital images by filtering based on vector values through the operating environment shown in FIG. 6.

It will be useful to explain these elements briefly from a high level and then to expand them in detail. The steps in this process are the following:
Step 1000—Creating sharpening software 200;
Step 2000—Receiving a digital image 310;
Step 3000—Filtering the digital image 310; and
Step 4000—Returning a sharpened image 340.
   Creating Sharpening Software

In an embodiment, one or more programmers at computing environment 100, shown in FIG. 6, create sharpening software 200 for use on computing environment 100. In another embodiment, sharpening software 200 may created on one server and loaded onto any other server for use on that other server.

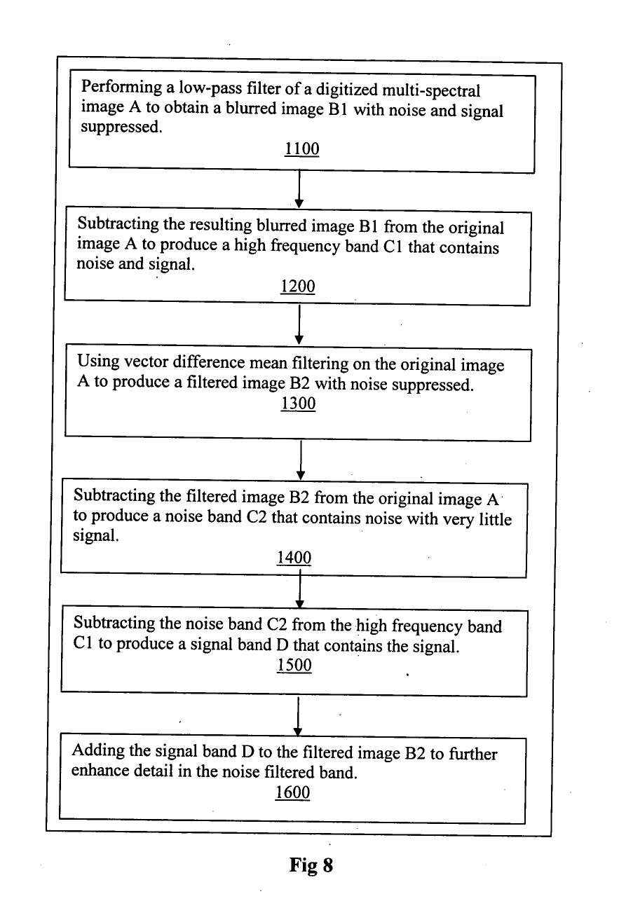

FIG. 8 shows the processes that sharpening software 200 accomplishes in an embodiment.
Step 1100—Performing a low-pass filter of a digitized multi-spectral image A to obtain a blurred image B1 with noise and signal suppressed;
Step 1200—Subtracting the resulting blurred image B1 from the original image A to produce a high frequency band C1 that contains noise and signal;
Step 1300—Using vector difference mean filtering on the original image A to produce a filtered image B2 with noise suppressed;
Step 1400—Subtracting the filtered image B2 from the original image A to produce a noise band C2 that contains noise with very little signal;
Step 1500—Subtracting the noise band C2 from the high frequency band C1 to produce signal band D that contains the signal; and
Step 1600—Adding the signal band D to the filtered image B2 to further enhance detail in the noise filtered band.
   Step 1100

In an embodiment, any appropriate low-pass filter, such as a spatial average or Gaussian blur, is performed on a digitized multi-spectral image A to obtain a blurred image B1 with noise and signal suppressed.

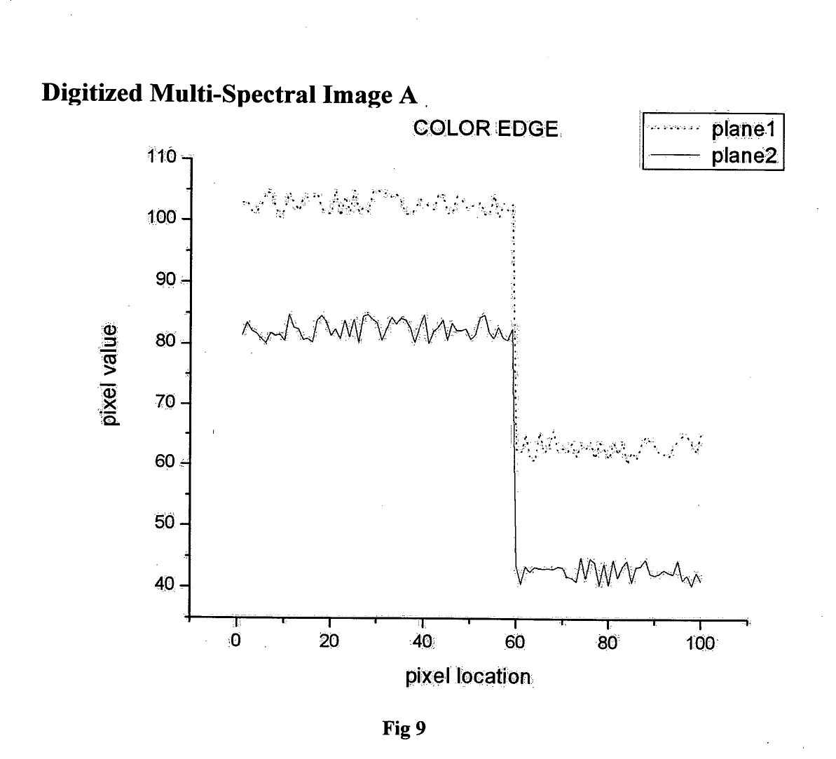

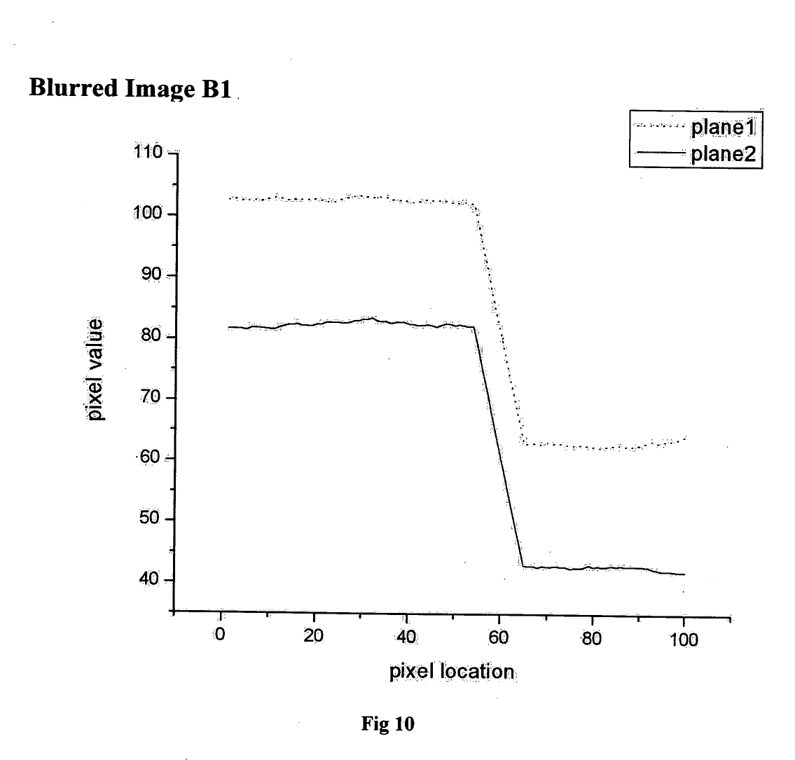

FIG. 9 is a graph showing a digitized multi-spectral image A with a color edge. FIG. 10 shows a blurred image B1 created by the low-pass filtering of digitized multi-spectral image A.

Step 1200

The resulting blurred image B1 is subtracted from the original image A to produce a high frequency band C1 that contains noise and signal.

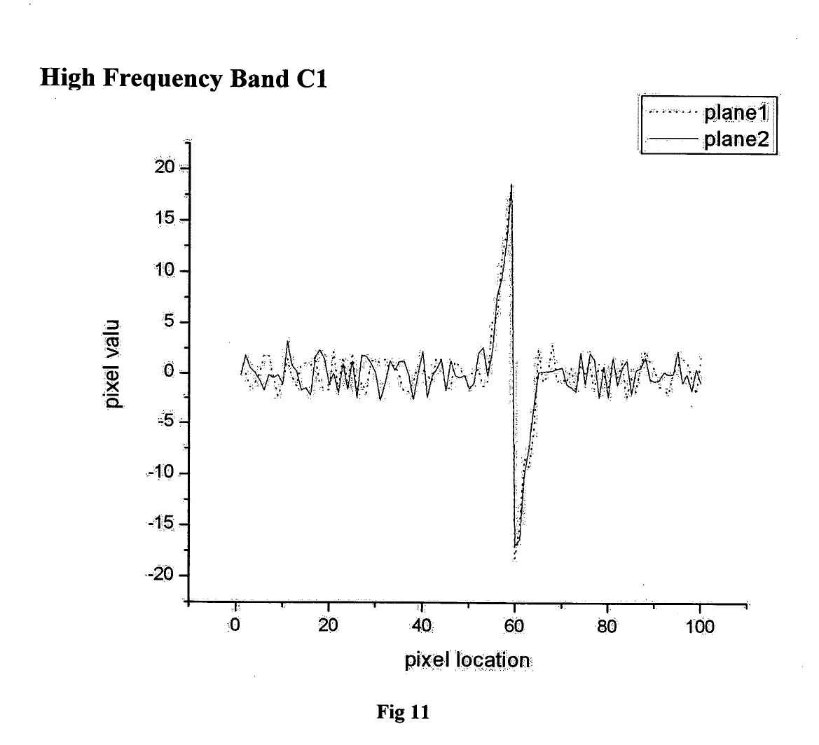

FIG. 11 shows a high frequency band C1 produced by subtracting blurred image B1 from the original image A.

Step 1300

Vector difference mean filtering is performed on the original image A, using any appropriate metric to suppress specific types of noise below any appropriate threshold, to produce a filtered image B2 with noise suppressed. U.S. utility patent application “System and Method for a Vector Difference Mean Filter for Noise Suppression” Ser. No. 10/992,409, cited above and incorporated by reference herein, explains in detail the method employed for vector difference mean filtering.

Through vector difference mean filtering, reduction of noise in digitized multi-spectral images is provided by filtering based on vector values rather than independent scalar values. Vector values refer to a pixel with two or more values. For this method, a metric is defined for pixel vector magnitude. A sliding processing kernel is also defined, with a specified shape, a specified number of pixels to be included in the kernel, and a specified value contrast threshold to avoid distorting edges and fine details. The metric and kernel are used to select pixels for computing filtering of the center pixel in a kernel. A statistical measurement is computed, for example by mean averaging the specified pixels, and the resulting value is made the value of-the center pixel of the kernel. The filtering process is applied throughout the image by making each pixel the center of a processing kernel. As a result, noise reduction can be accomplished in the filtered image without disturbing the balance among the color layers.

The major steps for vector difference mean filtering are
1. Defining a metric in pixel vector space;
2. Defining a sliding processing kernel;
3. Computing the metric values inside the kernel;
4. Thresholding the values to select relevant pixels; and
5. Filtering using the selected values to replace the center pixel.

### EXAMPLES

The vector difference filtering may be performed as discussed in pending application number “System and Method for a vector difference mean filter for noise suppression,” Ser. No. 10/992,409, cited above.

In one example, the vector values comprise a red scalar color component, a green scalar color: component, and a blue scalar component for each of the plurality of pixels in the image. In another example, there are six vector values- an amplitude of a red scalar color component, a phase of a red scalar color component, an amplitude of a green scalar color component, a phase of a green scalar color component, an amplitude of a blue scalar color component, and a phase of a blue scalar color component. In another example, there are four vector values a cyan scalar color component, a magenta scalar color component, a yellow scalar color component, and a black scalar color component value for each of the plurality of pixels a black scalar color component value for each of the plurality of pixels. Other vector representations may be used.

One useful metric is the simple vector distance between the values in the native coordinate space (for example, RGB space for color images). In an embodiment, the following metric is particularly useful for determining vector distance:
\sqrt{(x₁−x₂)²+(y₁−y₂)²+(z₁−z₂)²}

A kernel size is set from the center pixel of a kernel to define which pixels are related for the process of filtering. The kernel size may be either pre-defined or defined based on some criteria of the kernel or the image. A large kernel is effective for filtering noise for an image area with a large number of pixels, but has the disadvantage of suppressing fine details. A smaller kernel tends to preserve fine details better.

A kernel size of in the range of three pixels wide and three pixels to eleven pixels wide and eleven pixels tall have been found to be useful. In this example, a pre-defined value contrast threshold of 2.5 is useful. In other embodiments, statistical methods may be used to set the value contrast threshold.

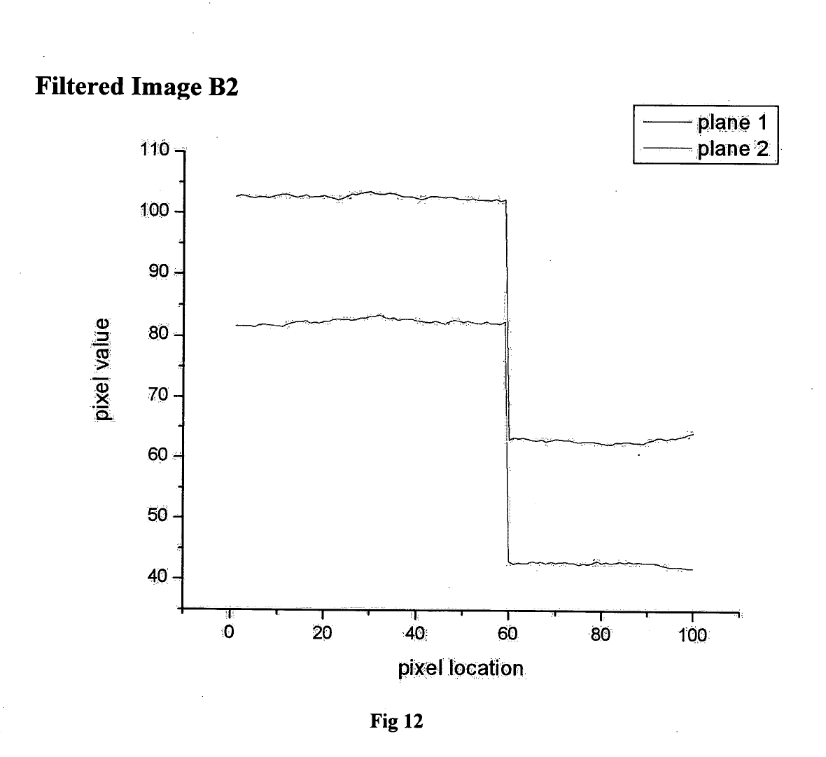

FIG. 12 shows a filtered image B2 produced by performing vector difference mean on the original image.

Step 1400

The filtered image B2 is subtracted from the original image A to produce a noise band C2 that contains noise with very little signal.

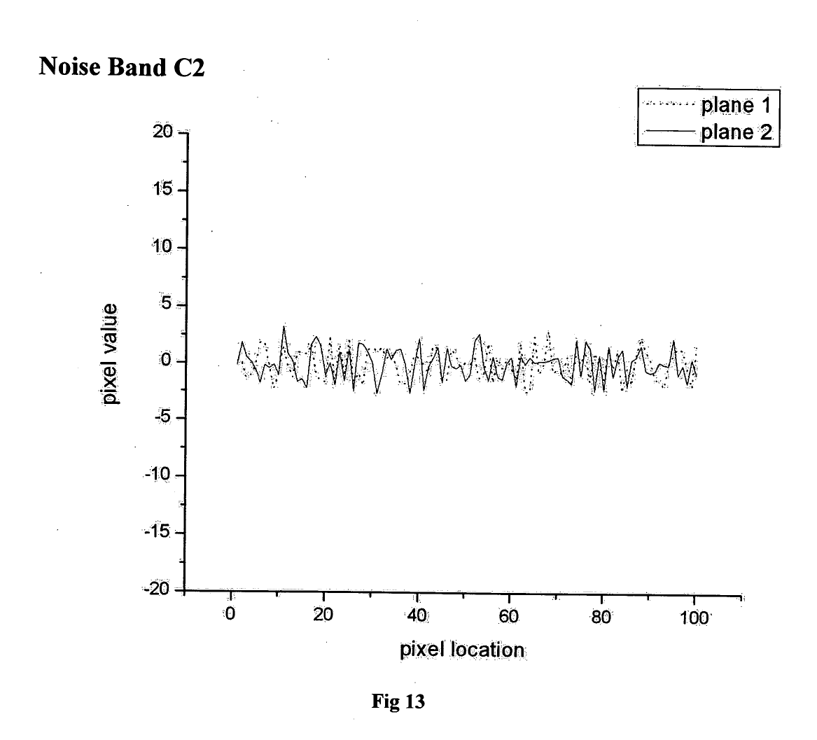

FIG. 13 shows a noise band C2 produced by subtracting filtered image B2 from the original image A.

Step 1500

The noise band C2 is subtracted from the high frequency band C1 to produce a signal band D that contains the signal. This step recovers the signal that was lost in Step 1100 without distorting color edge balance. This step exploits the fact that step 1400 produced an image C2 which was primarily noise. Subtracting this noise band C2 from image C1 permits the recovery of signal that was lost in the low pass filtering step 1100.

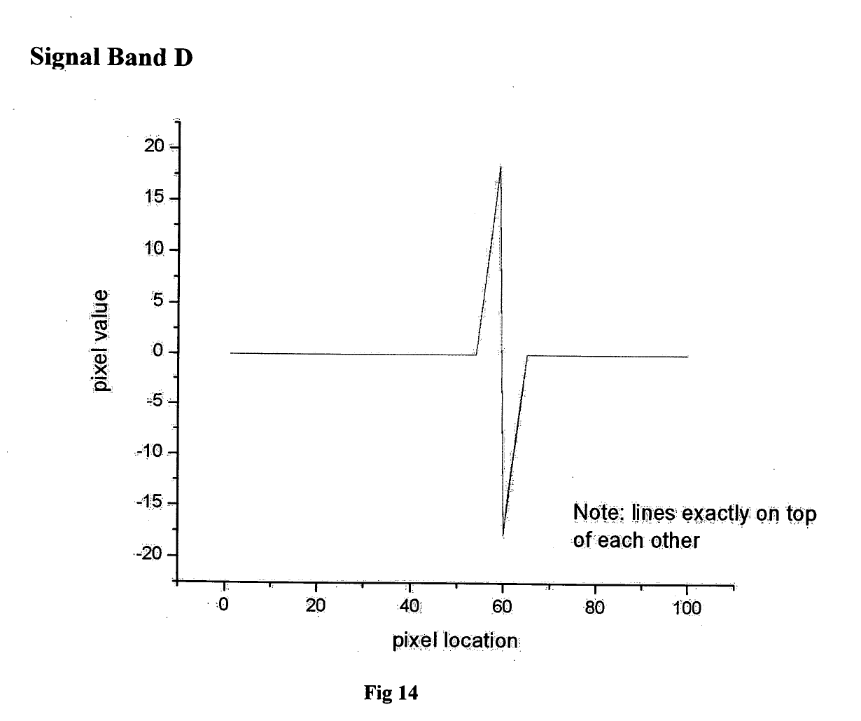

FIG. 14 shows a signal band D produced by subtracting the noise band C2 from the high frequency band C1.

Step 1600

The signal band D is added to the filtered image B2 to further enhance detail in the noise filtered band. The resulting image has sharpened details without increased noise.

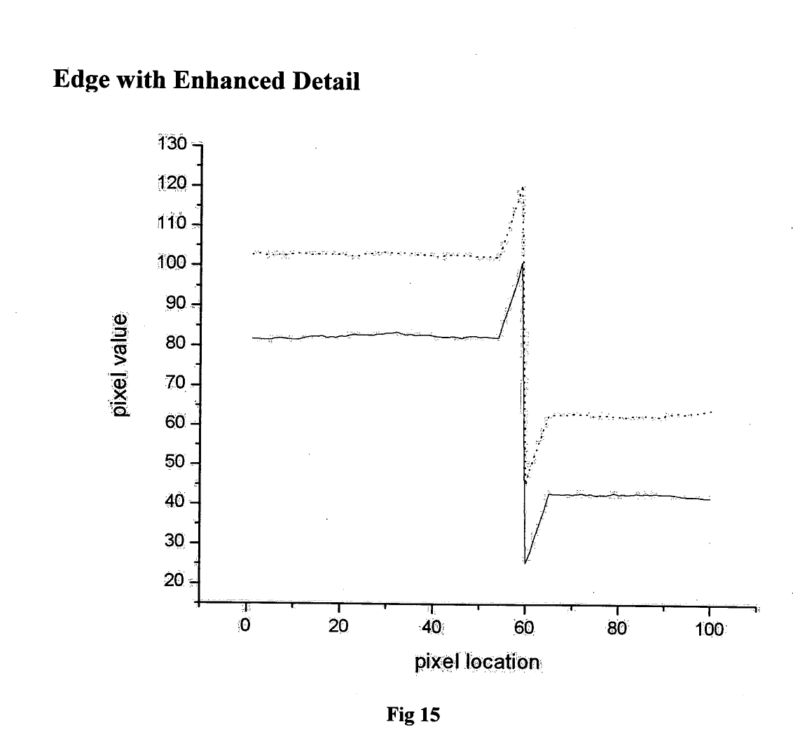

FIG. 15 shows the edge with enhanced detail produced by adding the signal band D to the filtered image B2.

Computer System Overview

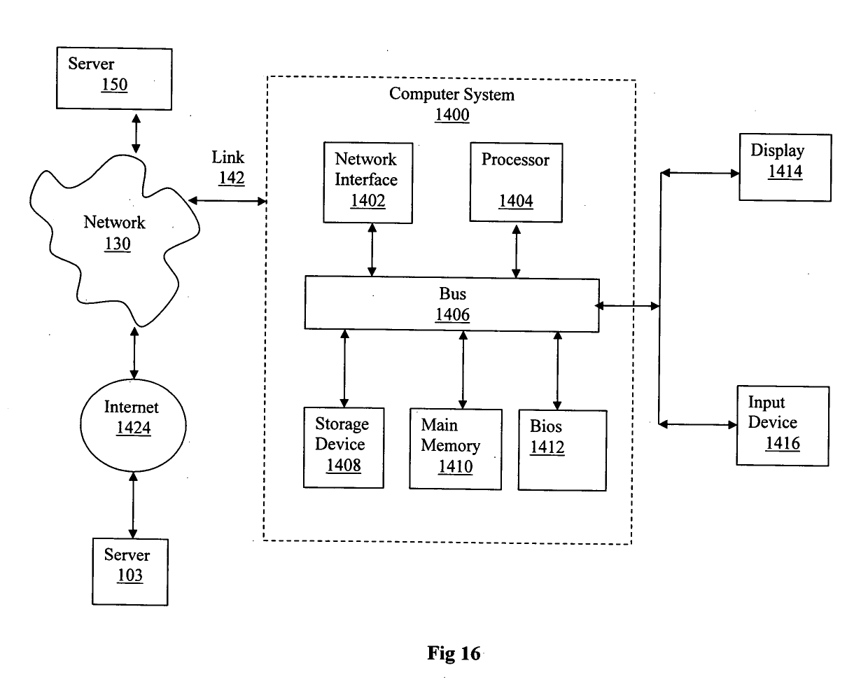

FIG. 16 is a block diagram that illustrates an example of a typical computer system 1400, well known to those skilled in the art, representing a computing environment 100 on which embodiments of the present invention can be implemented. This computer system 1400 comprises a network interface 1402 that provides two-way communications through a wired or wireless link 142 to a wired or wireless communications network 130 that uses any applicable, communications technology. For example, the network 130 can comprise a public telephone network, a wireless network, a local area network (LAN), and any known or not-yet-know applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LDC) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, an appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

### Alternate Embodiments

The previous extended description has explained some of the alternate embodiments of the present invention. It will be apparent to those skilled in the art that many other alternate embodiments of the present invention are possible without departing from its broader spirit and scope.

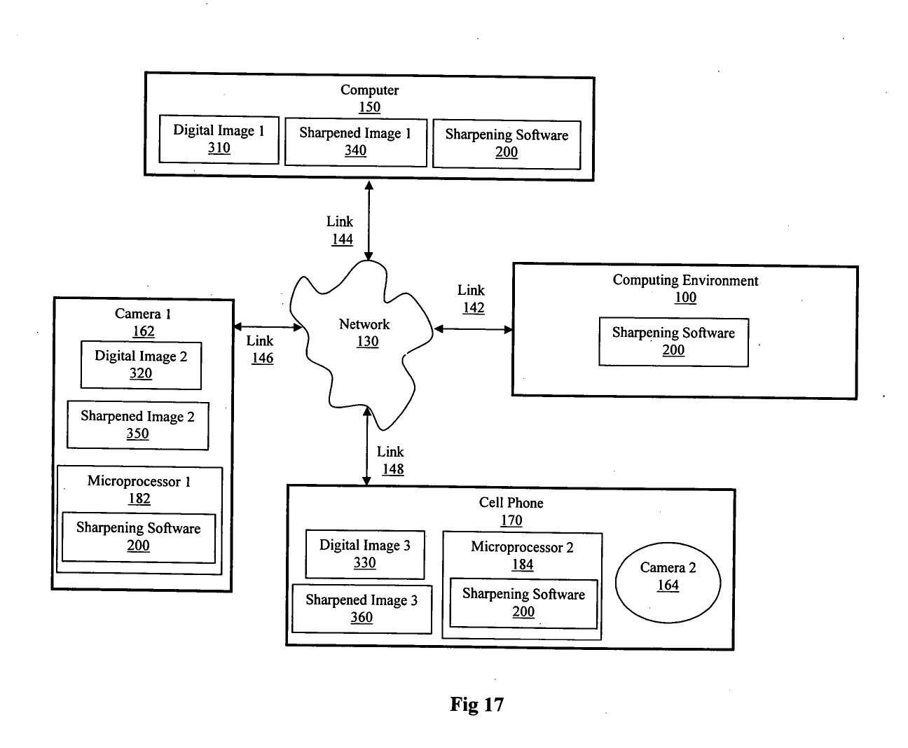

For example, FIG. 17 shows an operating environment where one or more programmers at computing environment 100 create sharpening software 200. Sharpening software 200 can then be transmitted to computer 150 and used there to process images such as digital image 1 310 and produce sharpened image 1 340.

Sharpening software 200 can also be placed on microprocessors, such as microprocessor 1 182 and microprocessor 2 184, and the microprocessors can be loaded on appropriate devices, such as camera 1 162 and cell phone 170, so that sharpening of digital images can be accomplished on these devices.

It will also be apparent to those skilled in the art that different embodiments of the present invention may employ a wide range of possible hardware and of software techniques. For example, the communication among computers could take place through any number of links, including wired, wireless, infrared, or radio ones, and through other communication networks beside those cited, including any not yet in existence.

Also, the term computer is used here in its broadest sense to include, for example, personal computers, laptops, telephones and cell phones with computer capabilities, cameras, personal data assistants (PDAs) and servers, and it should be recognized that it could include multiple servers, with storage and software functions divided among the servers.

Furthermore, in the previous description the order of processes, their numbered sequences, and their labels are presented for clarity of illustration and not as limitations on the present invention.

What is claimed is:

1. An automated method for sharpening a digitized, vector-valued, multi-spectral image A, the image comprising a plurality of pixels, the pixels each having vector values comprising a plurality of spectral components, the method comprising the computer-implemented steps of
performing a low-pass filter of image A to obtain a blurred image B1 with noise and signal suppressed;
subtracting the resulting blurred image B1 from the original image A to produce a high frequency band C1 that contains noise and signal;
using vector difference mean filtering on the original image A to produce a filtered image B2 with noise suppressed, such that the vector difference mean filtering filters the image A according to the vector values of image A;
subtracting the filtered image B2 from the original image A to produce a noise band C2, that contains noise with very little signal;
subtracting the noise band C2 from the high frequency band C1 to produce a signal band D that contains the signal, thereby recovering signal that was lost in the low pass filtering step; and
adding the signal band D to the filtered image B2 to further enhance detail in the noise filtered band.

2. The method of claim 1 wherein the low-pass filter is a spatial average filter.

3. The method of claim 1 wherein the vector values further comprise
a red scalar color component value for each of the plurality of pixels;
a green scalar color component value for each of the plurality of pixels; and
a blue scalar color component value for each of the plurality of pixels.

4. The method of claim 1 wherein the vector values further comprise
a red scalar color amplitude value for each of the plurality of pixels;
a red scalar color phase value for each of the plurality of pixels;
a green scalar color amplitude value for each of the plurality of pixels
a green scalar color phase value for each of the plurality of pixels;
a blue scalar color amplitude value for each of the plurality of pixels; and
a blue scalar color phase value for each of the plurality of pixels.

5. The method of claim 1 wherein the vector values further comprise
a cyan scalar color component value for each of the plurality of pixels;
a magenta scalar color component value for each of the plurality of pixels;
a yellow scalar color component value for each of the plurality of pixels; and
a black scalar color component value for each of the plurality of pixels.

6. The method of claim 1 wherein the vector difference mean filtering further comprises defining a metric, such that the metric uses the vector values of a first pixel and a second pixel to determine a metric value for the pixel; and
filtering each of the portion of the plurality of pixels within the image by designating a center pixel;
defining a sliding processing kernel relative to the center pixel, the kernel
comprising kernel pixels which include the center pixel and a plurality of pixels in proximity to the center pixel;
for each pixel associated with the sliding processing kernel
using the metric to compute the metric value for the pixel from the center pixel vector value and the pixel vector value,
comparing the metric value for the pixel to a threshold value for the kernel pixels in order to determine whether to include the pixel value in a filter calculation for the center pixel,
performing the filter calculation for the center pixel using the metric values for the those kernel pixels which were determined to be included in the filter calculation, and
replacing the vector value of the center pixel with a calculated vector value from the filter calculation for the center pixel.

7. The method of claim 6 wherein defining a metric further comprises
determining the simple vector distance between the vector values of the center pixel and a second pixel.

8. The method of claim 6 wherein defining a sliding processing kernel relative to the center pixel further comprises
selecting a kernel shape relative to the center pixel;
setting a kernel size; and
setting a value contrast threshold for the kernel.

9. The method of claim 8 wherein setting a kernel size further comprises
setting a kernel size dynamically based on the intensity of an image and on a magnitude threshold value.

10. The method of claim 9 wherein setting a kernel size dynamically based on the intensity of an image and on a magnitude threshold value further comprises
using the magnitude threshold value to detect that a portion of an image is of low intensity; and
setting a large kernel size for the low intensity portion of an image.

11. The method of claim 10 wherein using a magnitude threshold value to detect that an image is of low intensity further comprises
setting the magnitude threshold value as the standard deviation of the magnitude of the overall image subtracted from the mean overall magnitude of the image.

12. The method of claim 8 wherein setting a value contrast threshold for the kernel further comprises
using a statistical method to set a value contrast threshold.

13. The method of claim 8 wherein setting a value contrast threshold further comprises
setting a value contrast threshold dynamically through a statistical method comprising
taking the mean average of the vector values of the pixels in the kernel;
finding the standard deviation of the vector values of the pixels in the kernel; and
setting the value contrast threshold to the mean average plus the standard deviation.

14. An automated method for sharpening a digitized, vector-valued, multi-spectral image A, the image comprising a plurality of pixels, the pixels each having vector values comprising a plurality of spectral components, the method comprising the computer-implemented steps of
creating multi-spectral image sharpening software comprising
performing a low-pass filter of image A to obtain a blurred image B1 with noise and signal suppressed,
subtracting the resulting blurred image B1 from the original image A to produce a high frequency band C1 that contains noise and signal,
using vector difference mean filtering on the original image A to produce a filtered image B2 with noise suppressed, such that the vector difference mean filtering filters the image A according to the vector values of image A,
subtracting the filtered image B2 from the original image A to produce a noise band C2 that contains noise with very little signal,
subtracting the noise band C2 from the high frequency band C1 to produce a signal band D that contains the signal, thereby recovering signal that was lost in the low pass filtering step, and
adding the signal band D to the filtered image B2 to further enhance detail in the noise filtered band;
receiving a digital image;
sharpening the digital image using the sharpening software; and
returning a sharpened image.

15. The method of claim 14 wherein the low-pass filter is a spatial average filter.

16. The method of claim 14 wherein the vector values further comprise
a red scalar color component value for each of the plurality of pixels;
a green scalar color component value for each of the plurality of pixels; and
a blue scalar color component value for each of the plurality of pixels.

17. The method of claim 14 wherein the vector values further comprise
a red scalar color amplitude value for each of the plurality of pixels;
a red scalar color phase value for each of the plurality of pixels;
a green scalar color amplitude value for each of the plurality of pixels
a green scalar color phase value for each of the plurality of pixels;
a blue scalar color amplitude value for each of the plurality of pixels; and
a blue scalar color phase value for each of the plurality of pixels.

18. The method of claim 14 wherein the vector values further comprise
a cyan scalar color component value for each of the plurality of pixels;
a magenta scalar color component value for each of the plurality of pixels;
a yellow scalar color component value for each of the plurality of pixels; and
a black scalar color component value for each of the plurality of pixels.

19. The method of claim 14 wherein the vector difference mean filtering further comprises
defining a metric, such that the metric uses the vector values of a first pixel and a second pixel to determine a metric value for the pixel; and
filtering each of the portion of the plurality of pixels within the image by
designating a center pixel;
defining a sliding processing kernel relative to the center pixel, the kernel comprising kernel pixels which include the center pixel and a plurality of pixels in proximity to the center pixel;
for each pixel associated with the sliding processing kernel
using the metric to compute the metric value for the pixel from the center pixel vector value and the pixel vector value,
comparing the metric value for the pixel to a threshold value for the kernel pixels in order to determine whether to include the pixel value in a filter calculation for the center pixel,
performing the filter calculation for the center pixel using the metric values for the those kernel pixels which were determined to be included in the filter calculation, and
replacing the vector value of the center pixel with a calculated vector value from the filter calculation for the center pixel.

20. The method of claim 19 wherein defining a metric further comprises
determining the simple vector distance between the vector values of the center pixel and a second pixel.

21. The method of claim 19 wherein defming a sliding processing kernel relative to the center pixel further comprises
selecting a kernel shape relative to the center pixel;
setting a kernel size; and
setting a value contrast threshold for the kernel.

22. A system for sharpening digitized, vector-valued, multi-spectral images to suppress noise, the system comprising
a computing environment;
means for receiving a digitized multi-spectral image from a source environment;
sharpening software based on vector values of a plurality of pixels within the image,
the software providing a sharpened image by
performing a low-pass filter of image A to obtain a blurred image B1 with noise and signal suppressed,
subtracting the resulting blurred image B1 from the original image A to produce a high frequency band C1 that contains noise and signal,
using vector difference mean filtering on the original image A to produce a filtered image B2 with noise suppressed, such that the vector difference mean filtering filters the image A according to the vector values of image A,
subtracting the filtered image B2 from the original image A to produce a noise band C2 that contains noise with very little signal,
subtracting the noise band C2 from the high frequency band C1 to produce a signal band D that contains the signal, thereby recovering signal that was lost in the low pass filtering step, and
adding the signal band D to the filtered image B2 to further enhance detail in the noise filtered band; and
a means for transmitting the sharpened image to a target environment.
